(19) United States
(12) Patent Application Publication
(10) Pub. No.: US 2025/0226725 A1
(43) Pub. Date: Jul. 10, 2025

(54) TWIST AND HYPER-TWIST POWER TAKE-OFF DEVICES

(71) Applicant: The University of North Carolina at Charlotte, Charlotte, NC (US)

(72) Inventor: Wesley Bryant Williams, Charlotte, NC (US)

(21) Appl. No.: 18/987,613

(22) Filed: Dec. 19, 2024

Related U.S. Application Data
(60) Provisional application No. 63/617,786, filed on Jan. 5, 2024.

(51) Int. Cl. H02K 7/02; F03B 13/14; F03G 7/00; F03G 7/08; H02K 21/22

(52) U.S. Cl. CPC H02K 7/02; F03B 13/14; F03G 7/0252; F03G 7/08; H02K 21/22; F05B 2220/706

(57) ABSTRACT

The present disclosure is directed to a power take-off device including a shaft member, first and second end plates coupled to opposing ends of the shaft member, and first and second cords. Opposing ends of the first cord are secured to the first end plate to form a first loop and opposing ends of the second cord are secured to the second end plate to form a second loop. The first and second loops are configured to be wound into a twisted state or a hyper-twisted state when the shaft member is rotated in a first direction. When opposing tensile forces are applied to respective end points of the first and second loops, the shaft member is configured to rotate in a second opposing direction, thereby creating a moment of inertia such that the first loop and the second loop are rewound into the twisted state or the hyper-twisted state.

### CROSS-REFERENCE TO RELATED APPLICATION

This application claims priority to and the benefit of U.S. Provisional Patent Application No. 63/617,786, filed on Jan. 5, 2024, the contents of which are hereby incorporated by reference in its entirety.

### BACKGROUND

The present invention relates to the field of rotational output devices for power generation, renewable energy, and other applications.

### SUMMARY

According to some embodiments of the present invention, power take-off devices utilizing a twist or hyper-twist phenomenon are provided. The power take-off devices of the present invention are configured to transform a high force, low velocity linear input into a high-speed rotational output for power generation and other applications. In some embodiments, a power take-off device includes a rotor (or rotors) connected to a loop of wire or cord such as a flexible cord. From a twisted state, the cord is pulled, causing the loop to untwist and spin the rotor until it is twisted (or hyper-twisted) in the opposite direction and a second pull repeats the process. In some embodiments, the addition of permanent magnets into the rotor and placing it inside a stator may allow for electricity to be generated.

Another aspect of the present invention is directed to a power take-off including a shaft member, first and second end plates coupled to opposing ends of the shaft member, and first and second cords, each cord having opposing ends. The opposing ends of the first cord are secured to the first end plate to form a first loop having an end point and the opposing ends of the second cord are secured to the second end plate to form a second loop having an end point. The first and second loops are configured to be wound into a twisted state or a hyper-twisted state when the shaft member is rotated in a first direction. When opposing tensile forces are applied to respective end points of the first and second loops, the shaft member is configured to rotate in a second opposing direction, thereby creating a moment of inertia such that the first loop and the second loop are rewound into the twisted state or the hyper-twisted state.

Another aspect of the present invention is directed to a power take-off device including a shaft member, first and second end plates coupled to opposing ends of the shaft member, and first and second flexible cords having opposing ends. The opposing ends of the first flexible cord are secured to the first end plate to form a first loop having an end point and the opposing ends of the second flexible cord are secured to the second end plate to form a second loop having an end point, wherein the first and second flexible cord comprise a synthetic material. The power take-off device further includes an electromagnetic generator coupled to the shaft member. The first and second loops are configured to be wound into a twisted state or a hyper-twisted state when the shaft member is rotated in a first direction. When opposing tensile forces are applied to respective end points of the first and second loops, the shaft member is configured to rotate in a second opposing direction, thereby creating a moment of inertia such that the first loop and the second loop are rewound into the twisted state or the hyper-twisted state.

Another aspect of the present invention is directed to a method of producing electrical energy using a power take-off device. The power take-off device includes a shaft member, first and second end plates coupled to opposing ends of the shaft member, and first and second cords having opposing ends. The opposing ends of the first cord are secured to the first end plate to form a first loop having an end point and the opposing ends of the second cord are secured to the second end plate to form a second loop having an end point. The power take-off device further includes an electromagnetic generator coupled to the shaft member. The method includes (a) rotating the shaft member in a first direction to wind the first and second loops into a twisted state or a hyper-twisted state; and (b) applying opposing tensile forces to respective end points of the first and second loops which rotates the shaft member in a second opposing direction to create a moment of inertia of the shaft member relative to the electromagnetic generator, wherein the moment of inertia of the shaft member rewinds the first loop and the second loop into the twisted state or the hyper-twisted state.

It is noted that aspects of the invention described with respect to one embodiment, may be incorporated in a different embodiment although not specifically described relative thereto. That is, all embodiments and/or features of any embodiment can be combined in any way and/or combination. Applicant reserves the right to change any originally filed claim and/or file any new claim, accordingly, including the right to be able to amend any originally filed claim to depend from and/or incorporate any feature of any other claim or claims although not originally claimed in that manner. These and other objects and/or aspects of the present invention are explained in detail in the specification set forth below. Further features, advantages and details of the present invention will be appreciated by those of ordinary skill in the art from a reading of the figures and the detailed description of the preferred embodiments that follow, such description being merely illustrative of the present invention.

### BRIEF DESCRIPTION OF THE FIGURES

FIG. 1 is a schematic side view of a power take-off device according to embodiments of the present invention.

FIG. 2 is a schematic side view of another power take-off device according to embodiments of the present invention.

FIG. 3 is a photograph of an example prototype of the power take-off device shown in FIG. 2 according to embodiments of the present invention.

FIG. 4A is a schematic side view of another power take-off device according to embodiments of the present invention.

FIG. 4B is a schematic side view of an alternative configuration for the power take-off device shown in FIG. 4A according to embodiments of the present invention.

FIG. 5A is a photograph illustrating an example setup for testing the power take-off device of FIG. 4A according to embodiments of the present invention.

FIG. 5B is a photograph of the oscilloscope shown in FIG. 5A during testing of the power take-off device according to embodiments of the present invention.

FIG. 5C is a graph showing power (in Watts) over time (in seconds) generated by the power take-off device during testing according to embodiments of the present invention.

FIGS. 6A-6B illustrate a model and example data for the power take-off device shown in FIG. 4A with respect the rotor position and speed (left), the applied torque and force profile (center), and the damping torque and power (right) according to embodiments of the present invention.

FIGS. 7A-7C illustrate different twist configurations for the cords of the power take-off devices according to embodiments of the present invention. FIG. 7A illustrates a cord in an untwisted state, FIG. 7B illustrates a cord in a twisted state, and FIG. 7C illustrates a cord in a hyper-twisted (or super-twisted) state.

FIG. 8 is a schematic illustrating an example use of the power take-off devices according to embodiments of the present invention.

### DETAILED DESCRIPTION

The present invention now will be described more fully hereinafter in the following detailed description of the invention, in which some, but not all embodiments of the invention are described. Indeed, this invention may be embodied in many different forms and should not be construed as limited to the embodiments set forth herein; rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

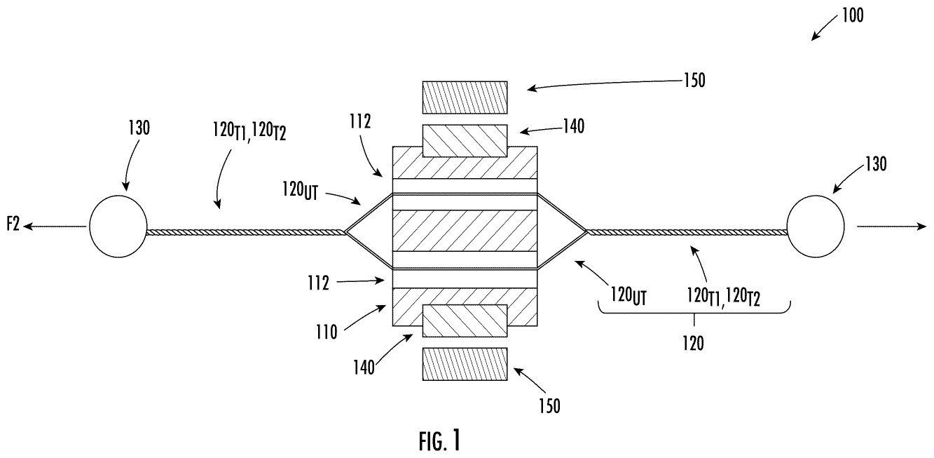

Pursuant to embodiments of the present invention, power take-off devices are provided. According to embodiments of the present invention, the power take-off devices utilize a twist or hyper-twist phenomenon to transform low-velocity linear motion into high-speed rotary motion which can be converted into power for consumption. Embodiments of the present invention will now be discussed in greater detail with reference to FIGS. 1-8.

Referring to FIG. 1, according to embodiments of the present invention, a power take-off device, designated broadly 100, is illustrated. The power take-off device 100 is based off a traditional whirligig toy which consists of a single loop that passes through a small rotor. The loop is then twisted to “charge” or “prime” the system. A tension is applied to the ends of the loop, causing it to unwind, which in turn causes the rotor to spin. The rotor reaches its maximum speed as the loop completely unwinds, but the inertia of the rotor and reduction in the loop tension causes the loop to wind in the opposite direction of the original twist. When the rotor stops at the maximum twist, it is ready for another application of tension to accelerate the rotor, this time in the opposite direction. Thus, linear displacement in a low frequency can be converted into rotary motion in an extremely high frequency.

As shown in FIG. 1, in some embodiments, the power take-off device 100 may include a rotor body 110 having two channels 112 extending therethrough. The rotor body 110 is typically cylindrical in shape. A single loop cord 120 extends through the two channels 112 of the rotor body 110. In some embodiments, the cord 120 is made from a synthetic material such as nylon, polyester, or polypropylene. The synthetic cord 120 is strong, flexible and durable, as well as light weight, cost-effective, and resistant to abrasion. In addition, in some embodiments, the synthetic cord 120 has a tight bend radius, thereby enabling the cord 120 to be highly twisted (i.e., hyper-twisted). In some embodiments, the cord 120 may have a diameter in a range of less than 1 millimeter to about 3 millimeters. In some embodiments, the rotor body 110 has a diameter in a range of between about 25 millimeters to about 150 millimeters, with proportional axial lengths. These dimension are, for example, when the power take-off device 100 is used in human power applications. However, these dimensions could increase significantly when the power take-off device 100 is used, for example, in marine energy applications (see, e.g., FIG. 8).

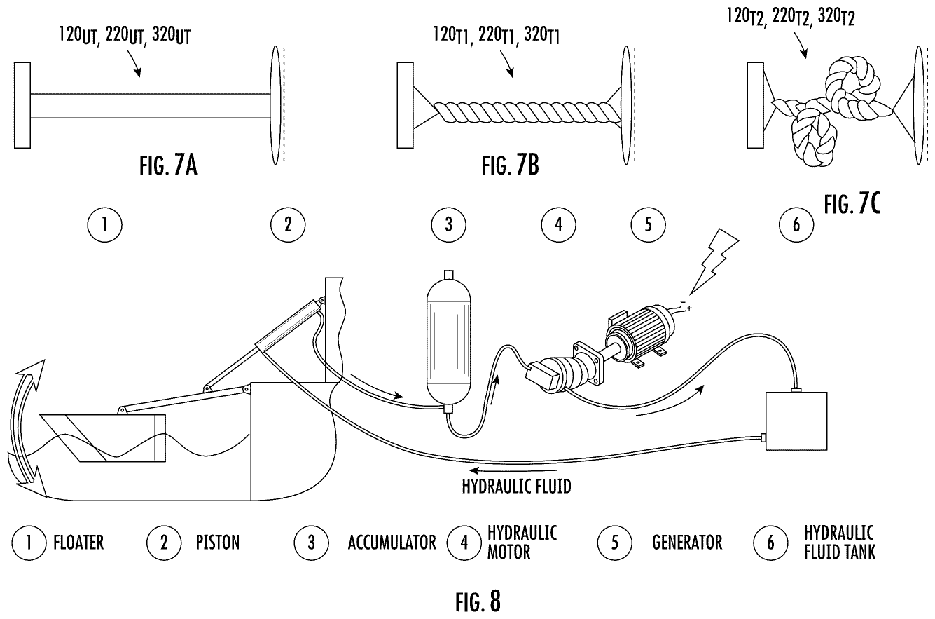

As shown in FIG. 1, the respective sections of the cord 120 extending through the channels 112 of the rotor body 110 are in an untwisted (uncoiled) state 120_{UT}. Rotation of the rotor body 110, may twist sections of the cord 120 extending from opposing sides of the rotor body 110 (i.e., wind the sections of cord 120 into a twisted (coiled) state 120_{T1} or a hyper-twisted (super-coiled) state 120_{T2}, see also FIGS. 7B-7C). In some embodiments, opposing tensile forces F1, F2 may be applied to opposing end points 130 of the single loop cord 120. In some embodiments, the end points 130 may be a handle or other like feature. The cyclical tension forces F1, F2 drive the rotation of the rotor body 110.

As further shown in FIG. 1, in some embodiments, one or more permanent magnets 140 may be affixed to the rotor body 110. In some embodiments, a stator 150 may be positioned outside (e.g., circumferentially) of the rotor body 110. Rotation of the rotor body 110 and magnets 140 within the stator 150 create a magnetic field to induce an electrical current in field windings of the stator 150, effectively converting mechanical energy into electrical energy. The operation of stators are well known to persons of ordinary skill in the art, and thus, will not be described in further detail.

As noted above, the twist or hyper-twist phenomenon transforms low-velocity linear motion into high-speed rotary motion. With respect to the power take-off device 100 illustrated in FIG. 1, by holding the opposing ends 130 of the single loop cord 120 fixed and rotating the rotor body 110, opposing sections of the single loop of cord 120 are twisted 120_{T1}, 120_{T2}. In some embodiments, the sections of cord 120 may be wound into a twisted (coiled) state (see, e.g., FIG. 7B). In other embodiments, the sections of cord 120 may be wound into a hyper-twisted (super-twisted or super-coiled) state (see, e.g., FIG. 7C). As used herein, the terms “hyper-twisted”, “super-twisted” or “super-coiled” refer to when a cord has been twisted or wound beyond the zero-twist point, thereby causing the cord to at least partially twist or wind around itself.

In operation, first, the power take-off device 100 is provided with the single loop cord 120 having initially twisted sections 120_{T1} or hyper-twisted sections 120_{T2} residing on opposing sides of the rotor body 110 (i.e., “primed” or “charged”). Opposing tensile forces F1, F2 are then applied to the ends 130 of the single loop cord 120, stretching the ends 130 of the cord 120 apart. This application of opposing tensile forces F1, F2 causes the twisted sections 120_{T1}, 120_{T2} of the single loop cord 120 to untwist (uncoil) in an opposite direction with respect to the initial twisted or hyper-twisted state 120_{T1}, 120_{T2}, which in turn spins (rotates) the rotor body 110. As noted above, the cord 120 is flexible, and thus can easily spiral tightly according to the rotation of the rotor body 110. When the single loop of cord 120 is completely unwound (i.e., in an untwisted state 120_{UT}), the moment of inertia (rotary inertia force) continues the rotation of the rotor body 110, winding the single loop of cord 120 in the opposite direction, and thus, retwisting the opposing sections of the cord 120 (i.e., back into a twisted or hyper-twisted state 120_{T1}, 120_{T2}).

In the untwisted stage 120_{UT}, the outward input force accelerates the rotor body 110 to a maximum rotation speed. When the rotor body 110 is returned to a wound state (opposite to the original twist) and the opposing tensile forces F1, F2 are applied again to the ends 130 of the single loop of cord 120, the rotor body 110 is accelerated in the opposite direction. The acceleration carries the moment of inertia of the rotor body 110 past the unwound state (i.e., untwisted state 120_{UT}) to twist the cord 120 in the opposite direction. At the fully untwisted stage (120_{UT}), the input force (i.e., tensile forces F1, F2) drops to approximately zero, allowing the rotational inertia of the rotor body 110 to recoil the opposing sections of the cord 120.

The cyclical application of the tensile forces F1, F2 are repeated which drives the rotor body 110 through cycles of winding (i.e., a twisted or hyper-twisted state 120_{T1}, 120_{T2}) and unwinding (i.e., an untwisted state 120_{UT}) in reversed directions. When the ends of the single loop of cord 120 are continuously pulled (i.e., opposing tensile forces F1, F2 applied) until reaching a tightly twisted or hyper-twisted state 120_{T1}, 120_{T2}, the speed of the rotor body 110 tends to be zero. At this time, when the outward pulling forces (i.e., opposing tensile forces F1, F2) are reapplied, the cord 120 will be untwisted again.

As noted above, when magnets 140 and a stator 150 are incorporated into the power take-off device 100 of the present invention, the cyclical application of tensile forces F1, F2 to the single loop cord 120 and resultant rotation of the rotor body 110 may induce an electrical current which could be used for generating power (i.e., electrical energy). For human power applications, an actuation frequency (tensile force) on the order of 1-2 Hz may be able to achieve rotational speeds of 100,000 RPM or more.

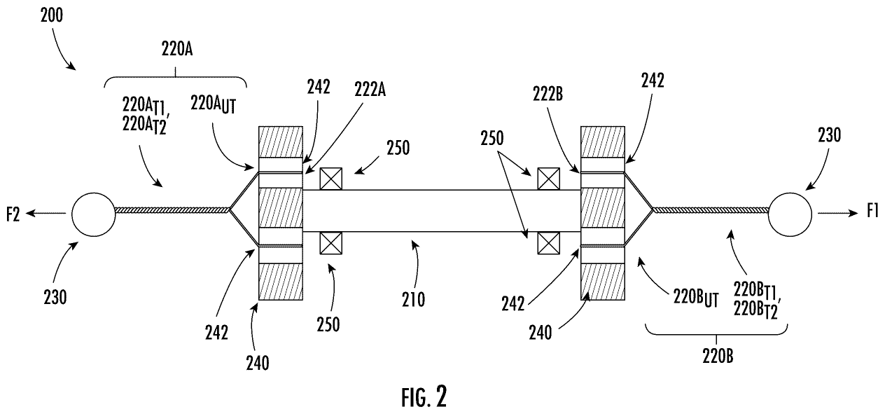

Referring now to FIG. 2, another power take-off device 200 according to embodiments of the present invention is illustrated. Properties and/or features of the power take-off device 200 may be as described above in reference to the power take-off device 100 shown in FIG. 1 and duplicate discussion thereof may be omitted herein for the purposes of discussing FIG. 2. Similar to the power take-off device 100 described herein, the power take-off device 200 may be used for generating power for a number of different applications including, but not limited to, human power applications and marine energy applications. As described in further detail below, in some embodiments, the power take-off device 200 differs from the power take-off device 100 described herein in that the power take-off device 200 includes a “double loop” cord configuration.

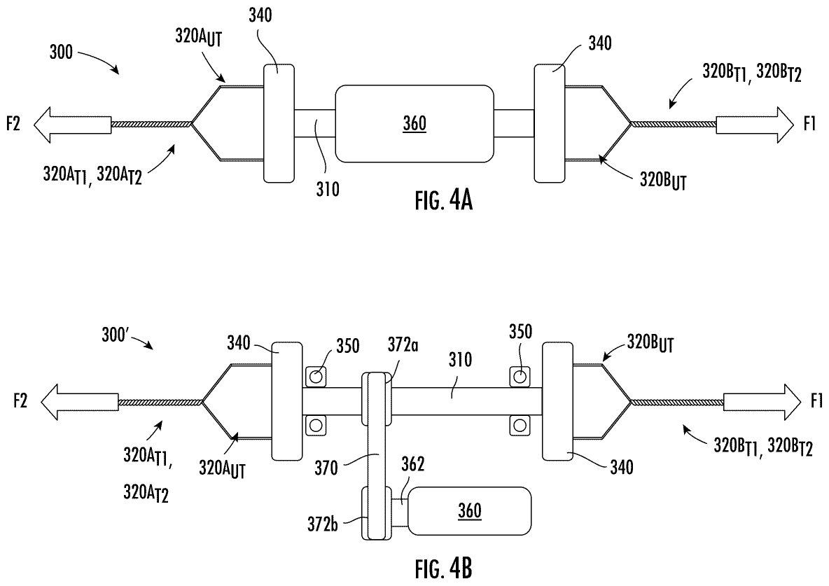

As shown in FIG. 2, in some embodiments, the power take-off device 200 may include a shaft member 210 having two end plates 240 coupled to opposing ends of the shaft member 210. In some embodiments, one or more bearings 250 may be coupled to the shaft member 210. The one or more bearings 250 may help support and guide the rotation of the shaft member 210, as well as may help reduce friction of the rotating shaft member 210. In some embodiments, other support features may be used in addition to, or instead of, the one or more bearings 250. As described in further detail below, the configuration and topology of the power take-off device 200 (i.e., having a shaft member 210 and end plates 240) provides more design freedom in that any rotor style can be affixed to the shaft member 210 (see, e.g., FIGS. 4A-4B) without consideration for having one or more of the cords 220A, 220B passing through, for example, the power take-off device 100 illustrated in FIG. 1.

Still referring to FIG. 2, the power take-off device 200 further includes two cords 220A, 220B, each cord 220A, 220B secured to a respective end plate 240. Similar to the cord 120 of the power take-off device 100, in some embodiments, the cords 220A, 220B of the power take-off device 200 are made from a synthetic material having a tight bend radius, thereby enabling the cords 220A, 220B to be highly twisted (i.e., hyper-twisted). The shaft member 210 is typically cylindrical in shape. The end plates 240 also typically have a cylindrical or disk shape. However, in some embodiments, the end plates 240 may have another shape, such as a polygonal shape, which may help with the initial twisting of the cords 220A, 220B, for example, when the power take-off device 200 is used in human power applications.

In some embodiments, each end plate 240 may comprise a pair of holes 242 which allow opposing ends 222A, 222B of the respective cords 220A, 220B to be secured to the end plate 240. It is noted that the ends 222A, 222B of each cord 220A, 220B may be secured to the end plates 240 in other known manners. As shown in FIG. 2, the respective sections of each cord 220A, 220B secured to the end plates 240 (i.e., extending through respective holes 242 in the end plates 240) are in an untwisted (uncoiled) state 220A_{UT}, 220B_{UT}. Rotation of the shaft member 210 (and coupled end plates 240), may twist sections of the cords 220A, 220B extending from opposing sides of the end plates 240 and shaft member 210 (i.e., twist the sections of cords 220A, 220B into a twisted (coiled) state 220A_{T1}, 220B_{T1} or a hyper-twisted (super-coiled) state 120_{T2}, see also FIGS. 7B-7C). In some embodiments, opposing tensile forces F1, F2 may be applied to opposing end points 230 of each cord 220A, 220B. In some embodiments, the end points 230 may be a handle or other like feature. The cyclical tension forces F1, F2 drive the rotation of the shaft member 210 (and end plates 240).

While not shown in FIG. 2, similar to the power take-off device 100 described herein, in some embodiments, one or more permanent magnets may be affixed to the shaft member 210 and a stator may be positioned outside of the shaft member 210 (e.g., circumferentially). Rotation of the shaft member 210 and magnets within the stator create a magnetic field to induce an electrical current in field windings of the stator to convert mechanical energy into electrical energy.

In operation, similar to the power take-off device 100, the power take-off device 200 is provided with the each cord 220A, 220B having initially twisted sections 220A_{T1}, 220B_{T1} or hyper-twisted sections 220A_{T2}, 220B_{T2} residing on opposing sides of the shaft member 210 (and respective end plates 240) (i.e., “primed”). Opposing tensile forces F1, F2 are applied to the end 230 each cord 220A, 220B, stretching the respective ends 230 of each cord 220A, 220B apart. This application of opposing tensile forces F1, F2 causes the respective twisted or hyper-twisted sections 220A_{T1}, 220B_{T1}, 220A_{T2}, 220B_{T2} of the cords 220A, 220B to untwist (uncoil) in an opposite direction with respect to the initial twisted or hyper-twisted state 220A_{T1}, 220B_{T1}, 220A_{T2}, 220B_{T2}, which in turn spins (rotates) the shaft member 210. As noted above, the cords 220A, 220B are flexible, and thus can easily spiral tightly according to the rotation of the shaft member 210. When each of the cords 220A, 220B are completely unwound (i.e., in an untwisted state 220A_{UT}, 220B_{UT}), the moment of inertia (rotary inertia force) continues the rotation of the shaft member 210, winding the cords 220A, 220B in the opposite direction, and thus, retwisting each cord 220A, 220B (i.e., back into a twisted or hyper-twisted state 220A_{T1}, 220B_{T1}, 220A_{T2}, 220B_{T2}).

The cyclical application of the tensile forces F1, F2 are repeated which drives the shaft member 210 through cycles of winding (i.e., a twisted or hyper-twisted state 220A_{T1}, 220B_{T1}, 220A_{T2}, 220B_{T2}) and unwinding (i.e., an untwisted state 220A_{UT}, 220B_{UT}) in reversed directions. When the ends of each loop of cord 220A, 220B are continuously pulled (i.e., opposing tensile forces F1, F2 applied) until reaching a tightly twisted or hyper-twisted state 220A_{T1}, 220B_{T1}, 220A_{T2}, 220B_{T2}, the speed of the shaft member 210 tends to be zero. At this time, when the outward pulling forces (i.e., opposing tensile forces F1, F2) are reapplied, the cords 220A, 220B will be untwisted again.

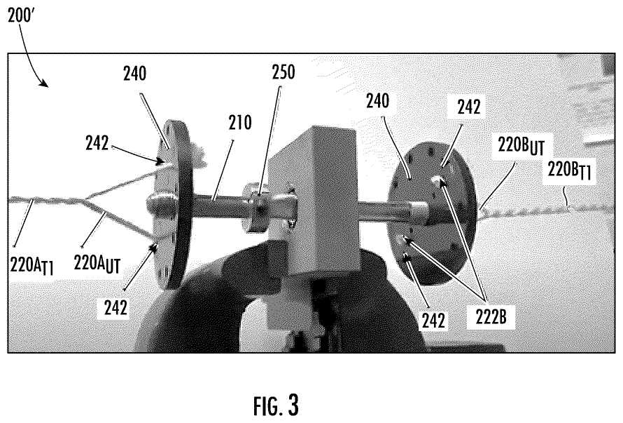

FIG. 3 is a photograph of an example prototype 200′ of the power take-off device 200 described herein and illustrated in FIG. 2. As shown in FIG. 3, sections of each cord 220A, 220B of the prototype 200′ are in a twisted state 220A_{T1}, 220B_{T1}.

Referring to FIGS. 4A-4B, alternative power take-off devices 300, 300′ according to embodiments of the present invention are illustrated. Properties and/or features of the power take-off devices 300, 300′ may be as described above in reference to the power take-off device 200 shown in FIG. 2 and duplicate discussion thereof may be omitted herein for the purposes of discussing FIGS. 4A-4B. Similar to the power take-off device 200 described herein, the power take-off devices 300, 300′ may be used for generating power for a number of different applications including, but not limited to, human power applications and marine energy applications. As described in further detail below, in some embodiments, the power take-off devices 300, 300′ differ from the power take-off device 200 described herein in that the power take-off devices 300, 300′ include an electromagnetic generator 360.

As shown in FIG. 4A, similar to the power take-off device 200 described herein, the power take-off device 300′ includes a shaft member 310 having two end plates 340 coupled to opposing ends of the shaft member 310. The shaft member 310 is coupled to an electromagnetic generator 360 at a central location. The shaft member 310 extends through the center of the electromagnetic generator 360 along a common axis. In some embodiments, the shaft member 310 may already be a component of the electromagnetic generator 360.

Also similar to the power take-off device 200 described herein, the power take-off device 300′ further includes two cords 320A, 320B, each cord 320A, 320B secured to a respective end plate 340 in a similar manner as the two cords 220A, 220B of power take-off device 200. The cords 320A, 320B of the power take-off device 300 may be made from a synthetic material having tight bend radius, thereby enabling the cords 320A, 320B to be highly twisted (i.e., hyper-twisted). The shaft member 310 is typically cylindrical in shape. The end plates 340 also typically have a cylindrical or disk shape. However, in some embodiments, the end plates 340 may have another shape such as polygonal.

Rotation of the shaft member 310 (and coupled end plates 340), may twist sections of the cords 320A, 320B extending from opposing sides of the end plates 340 and shaft member 310 (i.e., twist the sections of cords 320A, 320B into a twisted (coiled) state 320A_{T1}, 320B_{T1} or a hyper-twisted (super-coiled) state 320A_{T2}, 320B_{T2}). In some embodiments, opposing tensile forces F1, F2 may be applied to opposing end points 330 of each cord 320A, 320B. In some embodiments, the end points 330 may be a handle or other like feature. The cyclical tension forces F1, F2 drive the rotation of the shaft member 310 relative to the electromagnetic generator 360. Rotation of the shaft member 310 relative to the electromagnetic generator 360 creates a magnetic field to induce an electrical current, and thereby converts mechanical energy into electrical energy.

As shown in FIG. 4B, unlike the power take-off device 300 described herein, the shaft member 310 of the power take-off device 300′ does not share a common axis of the electromagnetic generator 360. Instead, in some embodiments, the electromagnetic generator 360 may be off-axis from the shaft member 310 and coupled to the shaft member 310 via a belt or geared transmission 370. For example, as shown in FIG. 4B, in some embodiments, the electromagnetic generator 360 may have a generator shaft member 362 extending from a central location. A gear 372a coupled to the shaft member 310 and a gear 372b coupled to the generator shaft member 362 may be coupled to together via the belt or geared transmission 370. Thus, rotation of the shaft member 310 of the power take-off device 300′ (driven by the cyclical tension forces F1, F2 applied to the cords 320A, 320B), in turn causes the generator shaft member 362 to rotate, thereby inducing an electrical current. Both approaches have advantages and disadvantages, summarized in Table 2.

In some embodiments, as shown in FIG. 4B, the power take-off device 300′ (or power take-off device 300) may include one or more bearings 350 coupled to the shaft member 310. As described herein, the one or more bearings 350 may help support and guide the rotation of the shaft member 310, as well as may help reduce friction of the rotating shaft member 310. In some embodiments, other support features may be used in addition to, or instead of, the one or more bearings 350.

The present subject matter will now be described more fully hereinafter with reference to the accompanying EXAMPLES, in which representative embodiments of the presently disclosed subject matter are shown. The presently disclosed subject matter can, however, be embodied in different forms and should not be construed as limited to the embodiments set forth herein. Rather, these embodiments are provided so that this disclosure will be thorough and complete, and will fully convey the scope of the presently disclosed subject matter to those skilled in the art.

### EXAMPLES

The following EXAMPLES provide illustrative embodiments. Certain aspects of the following EXAMPLES are disclosed in terms of techniques and procedures found or contemplated by the present inventors to work well in the practice of the embodiments. In light of the present disclosure and the general level of skill in the art, those of skill will appreciate that the following EXAMPLES are intended to be exemplary only and that numerous changes, modifications, and alterations can be employed without departing from the scope of the presently claimed subject matter.

### Coastal Structure Integrated Wave Energy Converter

Marine energy, in general, and wave energy, in particular, represent a renewable energy resource that has not yet been tapped, particularly in the United States, despite the scale and geographic distribution. The technical power potential for the United States alone is estimated at 2,300 TWh/year, which is a measure of the marine energy resource that could be harnessed with existing technology. Wave energy makes up a significant portion (˜60%) of the marine mix. Despite the relative predictability of the resource when compared to solar and wind energy generation and the proximity of the resource to population centers, wave energy development has lagged behind solar and wind energy development. This is largely due to the costs of deploying and operating energy generation resources in a marine environment, where devices are faced with a corrosive environment with variable loading and limited access.

Coastal structure integrated wave energy converters (CSI-WECs) have emerged as a technology to facilitate getting wave energy devices into the water by lowering the barriers to deployment and operations. These WECs use existing infrastructure as hard points for mounting devices in the wave resource and stable platforms for accessing the device during installation and maintenance operations. This reduces both the capital cost (leveraging existing infrastructure for mountings) and operations and maintenance costs by not requiring a vessel to access the device for maintenance. Other WECs include, but are not limited to, attenuators and point absorbers. Regardless of the specific topology, every WEC requires a power take-off system to transform the low-velocity, high-force input from the waves into a suitable form for performing useful work (typically producing electricity). In the case of electricity production, this normally requires high-speed rotational motion to work with existing generators. There are several incumbent and emerging PTO technologies that are used in WECs, each with strengths and weaknesses, as summarized in Table 1.

A potential use of the power take-off devices 100, 200, 300, 300′ of the present invention may be with respect to the hydraulic power take-off system for Eco Wave Power, as shown in FIG. 8. In this wall-mounted heave WEC, the wave forces drive up the float body which moves the piston, compressing a hydraulic fluid which is stored in an accumulator. That fluid is then released through a hydraulic motor, which drives a generator, producing electricity. The hydraulic fluid is then collected as part of the closed-loop system to be pressurized again on a subsequent stroke.

As described herein, the power take-off devices 100, 200, 300, 300′ may be driven similarly by the heave of an infrastructure mounted float body. The power take-off devices 100, 200, 300, 300′ of the present invention differ by eliminating the need for an accumulator and hydraulic motor and replacing the piston with power take-off devices 100, 200, 300, 300′, which directly transforms the linear motion of the WEC into electricity.

Physical Prototyping: A modular topology was built that allowed for testing across variations in the moment of inertia (MoI) and confirmed that the phenomenon persisted, even when the MoI increased by two orders of magnitude. The focus then shifted to how the twist or hyper-twist phenomenon could be used to drive a generator, and it quickly became apparent that the Traditional Hyper-twist Rotor (THR) topology would impose significant design constraints when integrated with a generator. The single continuous loop is required to pass through the center of the generator (see, e.g., power take-off device 100 illustrated in FIG. 1), restricting both the available space for the loop and the placement of the bearings needed to support the rotor. The power take-off devices 200, 300 illustrated in FIG. 2 and FIG. 4A, respectively, addresses these integration challenges by replacing the single continuous loop with two loops (i.e., cords 220A, 220B) affixed to rotors (e.g., ends plates 240) mounted outside the generator 360.

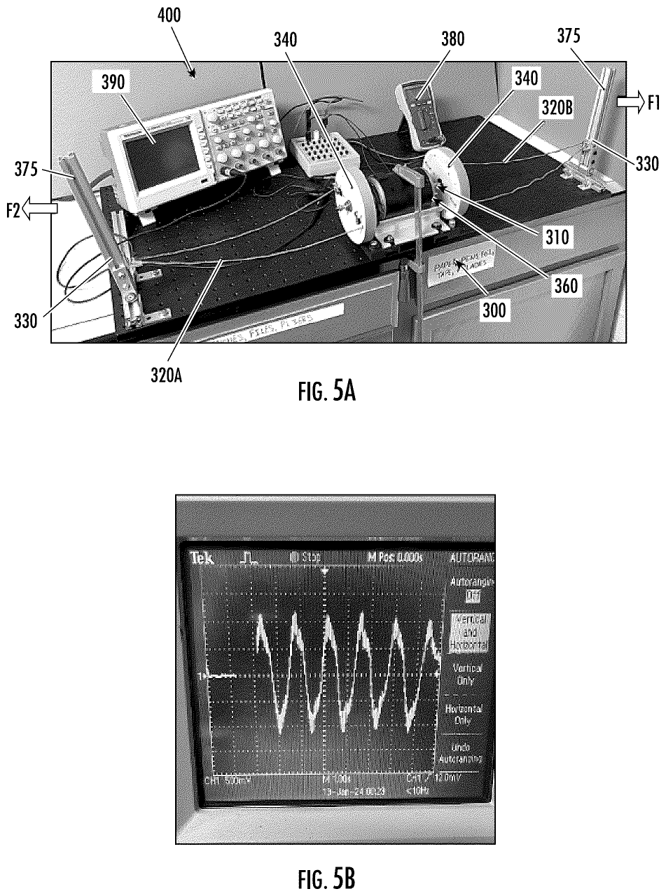

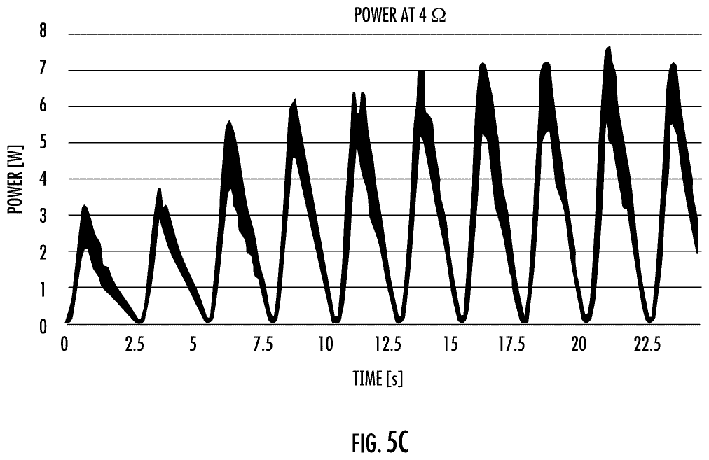

FIG. 5A is a photograph illustrating an exemplary setup 400 for testing the power take-off device 300 described herein according to embodiments of the present invention. As shown in FIG. 5A, the shaft member 310 of the power take-off device 300 extends through the center of the electromagnetic generator 360 along a common axis. Cords 320A, 320B are coupled to respective end plates 340. The cords 320A, 320B are in an untwisted state 320A_{UT}, 320B_{UT} in FIG. 5A. Opposing end points 330 of each cord 320A, 320B are secured to respective pivotable levers 375 configured to exert cyclical tension forces F1, F2 on the cords 320A, 320B to drive the rotation of the shaft member 310 relative to the electromagnetic generator 360.

The electromagnetic generator 360 is connected to an oscilloscope 390 and multimeter 380 to measure electrical signals generated by the power take-off device 300. The oscilloscope 390 displays a graphical representation of the electrical signals, whereas the multimeter may include an ammeter, voltmeter and ohmmeter to display precise measurements of amps, volts, and ohms, respectively. Use and operation of the oscilloscope 390 and multimeter 380 (and like devices) are well known to persons of ordinary skill in the art and will not be described in further detail.

FIG. 5B and FIG. 5C illustrate exemplary data obtained through testing of the power take-off device 300 according to embodiments of the present invention. As shown in FIG. 5B and FIG. 5C, according to embodiments of the present invention, the power take-off devices 100, 200, 300, 300′ of the present invention is able to convert linear motion (tensile forces F1, F2) into electrical signals to generate sufficient power. In other words, the power take-off devices 100, 200, 300, 300′ of the present invention provide a means to efficiently (size, weight, cost, etc.) transform a high-force, low velocity mechanical input into electricity for wave energy converters or human-power generators. Initial testing showed that the power take-off device 200, 300 could achieve the twist or hyper-twist operation, becoming the preferred topology moving forward.

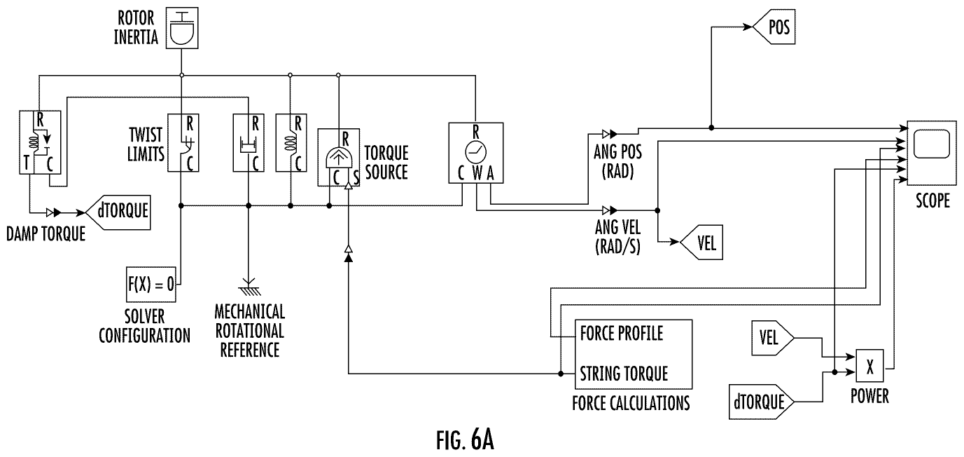

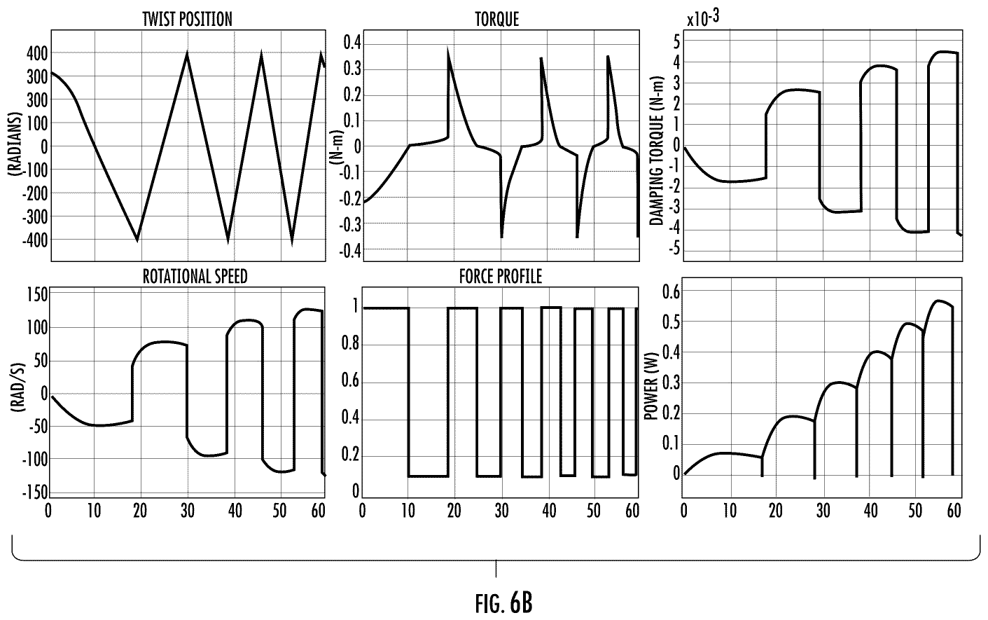

Numerical Modeling: In addition to the physical prototyping, physics-based numerical models were also developed in MATLAB Simscape to predict the behavior of the power take-off devices 200, 300 under different operating conditions. These parametric models were built using fundamental equations, allowing exploration of the design space to find advantageous (and problematic configurations). An example of the Simscape model is shown below in FIG. 6A.

The output from the model is seen in FIG. 6B, where the rotor position and velocity are seen on the left. The simulation represents the startup of the rotor, and the peak rotational speed is seen to increase with subsequent cycles, which matches the observed behavior of the physical prototypes. The central plots represent the torque and force profiles applied to the rotor. The torque profile has a peak torque when the loop is in its most twisted state that quickly falls off as it untwists. The force profile shown reflects the human operation of the power take-off device 200 in that 100% of the prescribed force is applied during the power stroke, but only 10% of that force is maintained during the recovery phase to maintain tension in the loop without unduly impeding the windup. The graphs on the right reflect the damper torque and power dissipated by the damper. In this purely mechanical model, the damper stands in as an analog for the energy a generator could extract.

With respect to Eco Wave Power, the power take-off devices 100, 200, 300, 300′ of the present invention provide a number of advantages. The power take-off devices 100, 200, 300, 300′ may be attractive option for power conversion because the power take-off devices do not go through as many energy conversions (pressurized fluid>hydraulic turbine>generator), with efficiency losses at each step (see, e.g., FIG. 8). Beyond external mechanisms for control, control over the power take-off devices 100, 200, 300, 300′ can be achieved by dynamically varying the electrical loading on the generator. The power take-off devices 100, 200, 300, 300′ provide reliability as the twist or hyper-twist phenomenon has been robust in testing to variations in the input frequency and force. Small-scale power take-off device prototypes (see, e.g., FIG. 3 and FIG. 5A) have been cycled over 100,000 times with commonly available loop materials without failure. In the event a loop (i.e., cord) needs to be replaced, it is a straightforward process that does not require specialized tools/training. The compliance of the loops on both ends of the power take-off devices 100, 200, 300, 300′ allows for easy connections to mounting points on a CSI-WEC during installation. In addition, unlike a mechanical gearbox or hydraulic cylinder, the power take-off devices 100, 200, 300, 300′ have no precision components that require tight tolerances for meshing or sliding interfaces.

Beyond the applications for WECs, as described herein, the power take-off devices 100, 200, 300, 300′ of the present invention could be a valuable human-powered generator independent of any integration with a larger system. As humans accumulate more electronic devices, they have a greater need for charging those devices, which becomes most apparent when conventional charging options are absent. The power take-off devices 100, 200, 300, 300′ of the present invention are more ergonomic than current hand-crank generators that are on the market and, with sufficient power output, could be marketed for outdoor enthusiasts or disaster preparedness kits.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

TABLE 1

| Technology | Strengths | Weaknesses |
|---|---|---|
| Mechanical | High volumetric torque | No inherent protection for |
| Gearboxes | density | overload conditions |
| | High mass torque density | Lubrication requirements |
| | Well-established | impact operations and |
| | technology with a long | maintenance |
| | history | Requires precision tolerances |
| Hydraulic | Captures linear WEC | Wear-based failure of seals |
| Systems | motion | Efficiency losses from |
| | Energy is readily stored | multiple steps |
| | in a hydraulic | Safety issues around the |
| | accumulator | transport and storage of high- |
| | | pressure fluids |
| | | Environmental impact of fluid |
| | | leaks |
| Direct Drive | Simple implementation | Limited efficiency of |
| | | generators at low-speed and |
| | | high-torque |
| Magnetic | Non-contact transmission | Limited gear ratios |
| Gearboxes | of torque | Volatility in the supply of |
| | Reduced need for | requisite rare-earth materials |
| | operations and | Lower torque densities (mass |
| | maintenance | and volume) compared to |
| | | mechanical gearboxes |

TABLE 2

| Aligned Axis Generator | |
|---|---|
| (AAG) Variant | Offset Axis Generator (OAG) Variant |
| Advantages | Advantages |
| Simple implementation | Allows for a speed increase between |
| Most experience with this | the shaft member and the generator |
| topology | shaft |
| | Can be adapted to more generator |
| | styles |
| | The generator is not subject to the |
| | axial loads driving the system |
| Disadvantages | Disadvantages |
| Requires a through-shaft | A more complicated mechanical |
| generator | arrangement with alignment |
| Unbalanced axial loads | considerations |
| may impact the generator | The power transmission between the |
| bearings | shaft member and the generator shaft |
| | introduces another failure mode. |

What is claimed is:

1. A power take-off device, the device comprising:
a shaft member;
a first end plate and a second end plate, the first and second end plates coupled to opposing ends of the shaft member; and
a first cord and a second cord, each cord having opposing ends, the opposing ends of the first cord secured to the first end plate to form a first loop having an end point and the opposing ends of the second cord secured to the second end plate to form a second loop having an end point,
wherein the first and second loops are configured to be wound into a twisted state or a hyper-twisted state when the shaft member is rotated in a first direction, and
wherein, when opposing tensile forces are applied to respective end points of the first and second loops, the shaft member is configured to rotate in a second opposing direction, thereby creating a moment of inertia such that the first loop and the second loop are rewound into the twisted state or the hyper-twisted state.

2. The power take-off device according to claim 1, wherein the first and second cords comprise a flexible, synthetic material.

3. The power take-off device according to claim 1, further comprising one or more bearings coupled to the shaft member.

4. The power take-off device according to claim 1, wherein the first and second end plates have a cylindrical or disk shape.

5. The power take-off device according to claim 1, wherein the first and second end plates each comprise a pair of holes, and the opposing ends of the first and second cords are secured to the respective end plates via the pair of holes.

6. The power take-off device according to claim 1, further comprising a handle at each end point of the first and second loops.

7. The power take-off device according to claim 1, further comprising one or more permanent magnets affixed to the shaft member and a stator positioned circumferentially around at least a portion of the shaft member, wherein rotation of the shaft member within the stator is configured to create a magnetic field to induce an electrical current.

8. The power take-off device according to claim 1, further comprising an electromagnetic generator coupled to the shaft member.

9. The power take-off device according to claim 8, wherein the electromagnetic generator is coupled to the shaft member at a central location, the shaft member extending through a center of the electromagnetic generator along a common axis.

10. The power take-off device according to claim 8, wherein the electromagnetic generator is off-axis from the shaft member and coupled to the shaft member via a belt or geared transmission.

11. The power take-off device according to claim 1, wherein the device is configured for use in human power applications.

12. The power take-off device according to claim 1, wherein the device is configured for use in a wave energy converter.

13. A power take-off device, the device comprising:
a shaft member;
a first end plate and a second end plate, the first and second end plates coupled to opposing ends of the shaft member;
a first flexible cord and a second flexible cord, each cord having opposing ends, the opposing ends of the first flexible cord secured to the first end plate to form a first loop having an end point and the opposing ends of the second flexible cord secured to the second end plate to form a second loop having an end point, wherein the first and second flexible cord comprise a synthetic material; and
an electromagnetic generator coupled to the shaft member,
wherein the first and second loops are configured to be wound into a twisted state or a hyper-twisted state when the shaft member is rotated in a first direction,
wherein, when opposing tensile forces are applied to respective end points of the first and second loops, the shaft member is configured to rotate in a second opposing direction, thereby creating a moment of inertia such that the first loop and the second loop are rewound into the twisted state or the hyper-twisted state.

14. The power take-off device according to claim 13, wherein the first and second end plates have a cylindrical or disk shape.

15. The power take-off device according to claim 13, wherein the first and second end plates each comprise a pair of holes, and the opposing ends of the first and second flexible cords are secured to the respective end plates via the pair of holes.

16. The power take-off device according to claim 13, further comprising a handle at each end point of the first and second loops.

17. The power take-off device according to claim 13, wherein the electromagnetic generator is coupled to the shaft member at a central location, the shaft member extending through a center of the electromagnetic generator along a common axis.

18. The power take-off device according to claim 13, wherein the electromagnetic generator is off-axis from the shaft member and coupled to the shaft member via a belt or geared transmission.

19. A method of producing electrical energy using a power take-off device, wherein the power take-off device comprises a shaft member, a first end plate and a second end plate, the first and second end plates coupled to opposing ends of the shaft member, a first cord and a second cord, each cord having opposing ends, the opposing ends of the first cord secured to the first end plate to form a first loop having an end point and the opposing ends of the second cord secured to the second end plate to form a second loop having an end point, and an electromagnetic generator coupled to the shaft member, the method comprising:
(a) rotating the shaft member in a first direction to wind the first and second loops into a twisted state or a hyper-twisted state; and
(b) applying opposing tensile forces to respective end points of the first and second loops which rotates the shaft member in a second opposing direction to create a moment of inertia of the shaft member relative to the electromagnetic generator, wherein the moment of inertia of the shaft member rewinds the first loop and the second loop into the twisted state or the hyper-twisted state.

20. The method according to claim 19, further comprising repeating step (b) to continue rotation of the shaft member relative to the electromagnetic generator.
